(19) United States
(12) Patent Application Publication
(10) Pub. No.: US 2006/0066551 A1
(43) Pub. Date: Mar. 30, 2006

(54) Inverter driving circuitry

(76) Inventors: Chin-Wen Chou, Taipei Hsien (TW); Ying-Nan Cheng, Taipei Hsien (TW); Chin-Biau Chung, Taipei Hsien (TW)

Correspondence Address: BIRCH STEWART KOLASCH & BIRCH, PO BOX 747, FALLS CHURCH, VA, 22040-0747, US

(21) Appl. No.: 10/950,600

(22) Filed: Sep. 28, 2004

(51) Int. Cl. G09G 3/36

(52) U.S. Cl. 345/94

(57) ABSTRACT

The present invention pertains to an inverter driving circuitry, which receives an input power signal from a power unit and outputs another power signal to drive a load to operate. The inverter driving circuitry is designed to be that a sinusoidal-wave signal generator receives a power signal, and outputs a sinusoidal-wave frequency signal to a signal amplifier in order to provide a gain and output a driving signal, and a transformer unit receives the driving signal to perform a power transformation and output another power signal to drive a load to operate. Thereby, the inverter driving circuitry of the present invention can take the place of a conventional design comprising pulse width modulators (PWM), power switches (MOSFET) and inductances (L), and achieves that the transformer unit is driven to operate by a standard sinusoidal-wave frequency driving signal.

### FIELD OF THE INVENTION

The present invention relates to an inverter driving circuitry, particularly to one whose transformer unit is driven by a standard sinusoidal-wave frequency driving signal.

### BACKGROUND OF THE INVENTION

A conventional driving device is adopted to output a high voltage through a ceramic transformer to light up a cold cathode fluorescent lamp (CCFL) of a liquid crystal display (LCD) panel of a desktop or notebook computer, a portable digital assistant (PDA), or a Webpad, which are sold in the current market. The conventional driving device is described below.

Referring to FIG. 1A, a conventional piezoelectric inverter driving circuitry utilizes a power unit 14 to input a power signal to a pulse width modulator 10 and a power switch 13(MOSFET), and the pulse width modulator 10 outputs a resonant frequency to control the operation of the power switch 13.

The power switch 13 is made of a P-type semiconductor (P-MOSFET) 131 and a N-type semiconductor (N-MOSFET) 132 i.e. a push-pull amplifier. When the pulse width modulator 10 outputs a positive-phase frequency signal wave 11, the P-type semiconductor 131 will become conductive during low-level stages. Another positive-phase frequency signal wave 12 is used to push the N-type semiconductor 132, which becomes conductive during high-level stages.

As the working voltage waveform (driving signal) output from the conventional power switch 13 is a square-wave switching signal, the driving signal is coupled to an inductance 15 to undertake a Hume-Rothery transformation in order to form a quasi-sinusoidal voltage wave. The quasi-sinusoidal voltage wave is input to a transformer unit 16 to activate a piezoelectric effect and produce an electric power output to a load 17.

Referring to FIG. 1B, there is a time lag between the positive-phase signal wave 11 and 12 i.e. the dead time 111, and the function of the dead time 111 is to avoid an electric short resulting from that the P-type semiconductor 131 and the N-type semiconductor 132 become conductive simultaneously. The electric short thereof will result in the burnout of the P-type semiconductor 131 and the N-type semiconductor 132. Owing to the dead time 111, the quasi-sinusoidal voltage wave, which is output after the modification of the inductance 15, is not a standard sinusoidal wave.

Further, as the conventional inverter driving circuitry need utilize the pulse width modulator 10, power switch 13 and inductance 15 to accomplish its function of the driving operation of a power signal, the numerous electronic elements will easily result in a physical power loss.

### SUMMARY OF THE INVENTION

The primary objective of the present invention is to improve the aforementioned drawbacks of the conventional inverter driving circuitry, via simplifying the driving circuitry thereof, which undertakes a frequency output and wave transformation of a working voltage via a pulse width modulator, power switch and inductance.

The present invention directly utilizes a sinusoidal-wave signal generator and a signal amplifier to form a driving circuitry of a transformer unit. The sinusoidal-wave signal generator receives a power signal and then outputs a sinusoidal-wave frequency signal to the amplifier, and then the amplifier provides a gain for an output driving signal. The transformer unit receives the driving signal, and undertakes a resonant reaction to outputs another power signal to drive a load to operate. Thereby, the present invention can takes the place of the pulse width modulator, power switch and inductance of the conventional inverter driving circuitry, and decreases the quantity of electronic elements. Further, as the sinusoidal-wave signal generator directly outputs the sinusoidal-wave frequency signal, which corresponds to the operating frequency of the transformer unit, there is no power loss resulting from the waveform transformation, and the transformer unit can operates under the driving signal of a standard sinusoidal-wave frequency to develop the best working efficiency.

### BRIEF DESCRIPTION OF THE DRAWINGS

FIG. 1A is a schematic diagram of a conventional inverter driving circuitry.

FIG. 1B is a schematic diagram of a time lag between the positive-phase signal wave 11 and 12 in FIG. 1A.

FIG. 2 is a schematic diagram of an inverter driving circuitry according to one aspect of the present invention.

FIG. 3 is a schematic diagram showing an application of the present invention in a first multi-load circuitry according to one embodiment of the present invention.

FIG. 4 is a schematic diagram showing an application of the present invention in a second multi-load circuitry according to one embodiment of the present invention.

FIG. 5 is a schematic diagram showing an application of the present invention in a circuitry with a push-pull transformer unit according to one embodiment of the present invention.

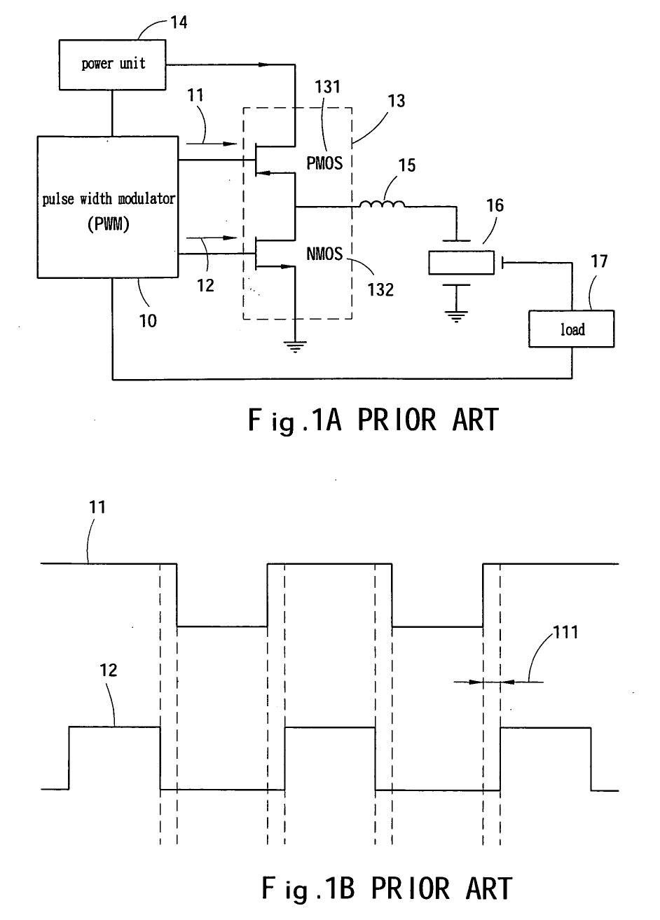

### DETAILED DESCRIPTION OF THE PREFERRED EMBODIMENTS

Referring to the attached drawings, the detailed description of the present invention will be stated below.

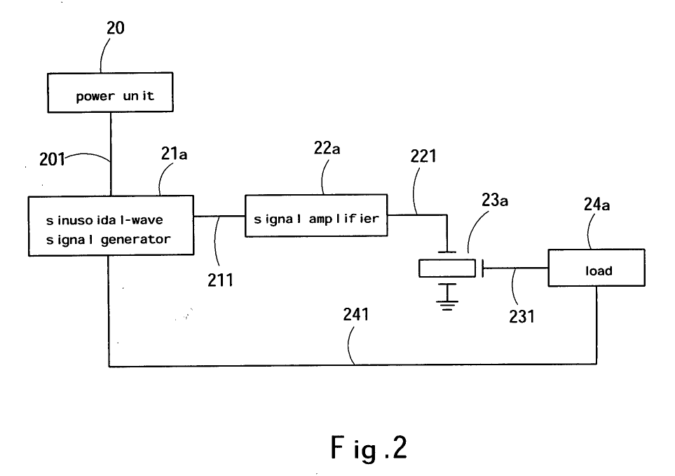

Referring to FIG. 2 a schematic diagram of an inverter driving circuitry according to one aspect of the present invention, from a view of the whole system, the present invention receives a first power signal 201 from power unit 20 at the beginning, and outputs a high voltage second power signal 231 to drive a load 24a to operate in the last. The power unit 20 refers to a device which outputs a direct current coming from a rectified alternating current. The input first power 201 signal can be a direct current signal modified by a power factor regulator (usually 12V˜48V according to the current technology) or a pulse direct current rectified directly (155V according to the current technology). The inverter driving circuitry of the present invention has a sinusoidal-wave signal generator 21a (function generator), which receives the first power signal 201 and output a sinusoidal-wave frequency signal 211. As the sinusoidal-wave signal generator 21a itself is a signal source and a wave-generating circuitry is installed therein, it is not necessary to additionally install a pulse width modulator inside the sinusoidal-wave signal generator 21a. The sinusoidal-wave signal generator 21a can directly output a resonant frequency wave signal, which is directly a sinusoidal-wave frequency signal. The sinusoidal-wave frequency signal 211 is sent to a signal amplifier 22a, which provides a gain and amplification in order to output a driving signal 221. The gain of the signal includes not only a linear voltage gain but also a current gain of the signal. As a transformer unit 23a receives the driving signal 221, the transformer unit 23a will undertake a resonant reaction and output a second power signal 231 to drive a load 24a to operate. The load 24a outputs a feedback signal 241 to the sinusoidal-wave signal generator 21a. As the sinusoidal-wave frequency signal 211 and the driving signal 221 is just the very sinusoidal-wave signal, the operation interruption, resulting from the dead time of the conventional switch, will not occur in the transformer unit 23a. Further, as the sinusoidal-wave is defined directly corresponding to the resonant frequency of the transformer unit 23, a power loss resulting from the transformation between a square wave and a sinusoidal wave, will not occur either. Thus, in comparison with the conventional design comprising the pulse width modulator, power switch and inductance, the present invention can develop the best operation capacity under the normal operation of the transformer unit 23a. Further, the reduction of the quantity of the electronic elements is advantageous to the layout of the electronic circuitry, and the whole circuitry board volume can also be reduced thereby. The transformer unit 23a mentioned in the specification of the present invention can be a winding transformer or a piezoelectric transformer. The attached figures in this specification only illustrate those embodiments utilizing the piezoelectric transformer, and as the circuitries of those embodiments utilizing the winding transformer are similar, the figures thereof will not be repeated herein.

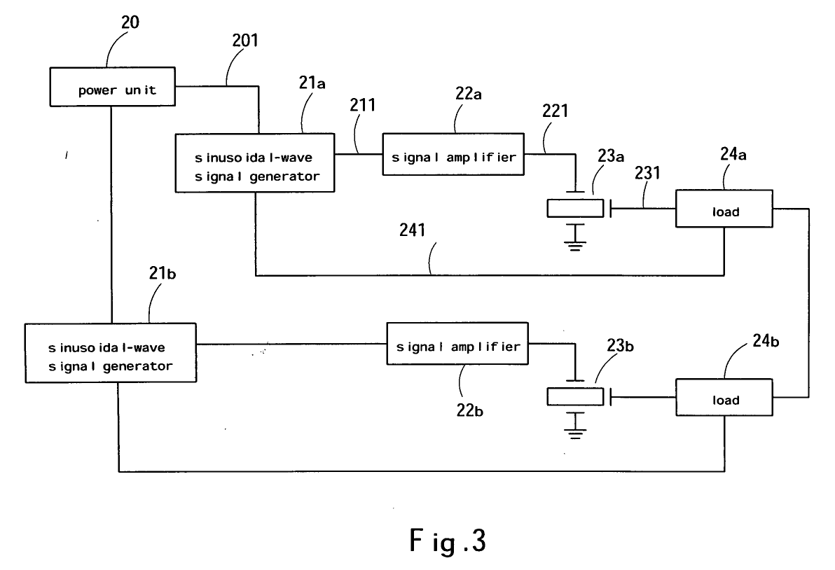

According to one embodiment of the present invention, the present invention can also apply to multi-load cases, such as a LCD panel with multiple CCFLs. Referring to FIG. 3 a schematic diagram showing an application of the present invention in a first multi-load circuitry, according to the quantity of the loads, multiple sets of sinusoidal-wave signal generator 21a, 21b, signal amplifier 22a, 22b and transformer unit 23a, 23b are provided corresponding to the load 24a, 24b. The operation thereof is similar to those described above.

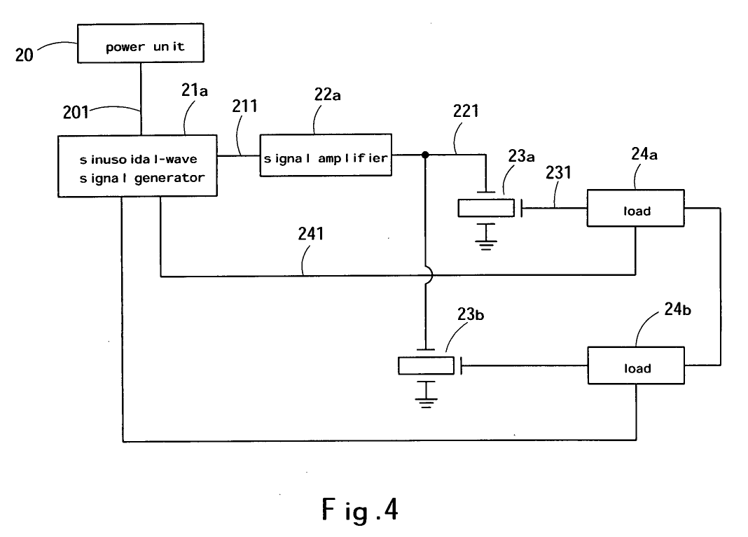

Referring to FIG. 4 a schematic diagram showing an application of the present invention in a second multi-load circuitry, according to one embodiment of the present invention, only one set of sinusoidal-wave signal generator 21a and signal amplifier 22a is provided, and the output driving signal 221 will synchronously drive both two transformer unit 23a, 23b and both two load 24a, 24b.

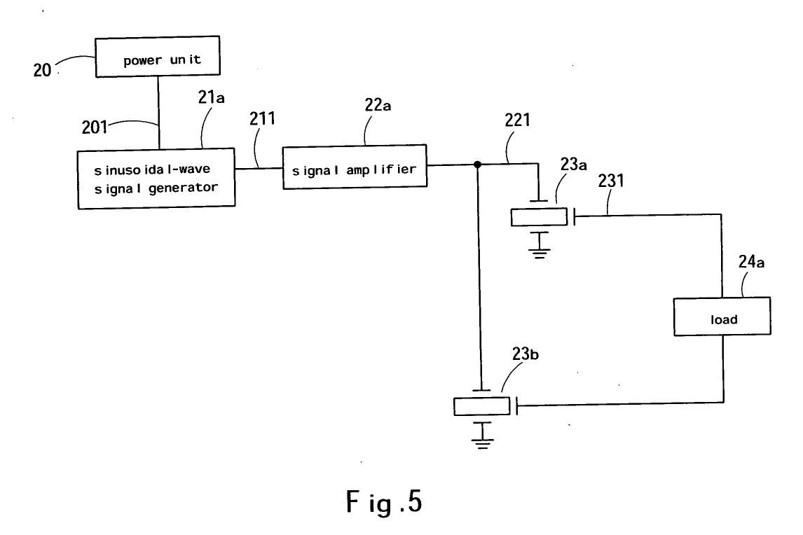

Referring to FIG. 5 a schematic diagram showing an application of the present invention in a circuitry with a push-pull transformer unit, as the load 24a in FIG. 5 (such as a long lamp) needs more power than the loads in FIG. 4, according to one embodiment of the present invention, two transformer unit 23a, 23b or more are provided, which output power in a push-pull manner to drive the load 24a. The sinusoidal-wave signal generator 21a and the signal amplifier 22a coupled to the front of the two transformer unit 23a, 23b in FIG. 5 are also adaptable to the circuitry architecture in FIG. 5.

Those described above are only the preferred embodiments of the present invention, it is not intended to limit the scope of the present invention. Any equivalent modification and variation according to the appended claims of the present invention is to be included within the scope of the present invention.

What is claimed is:

1. An inverter driving circuitry, which receives a first power signal from a power unit and outputs a second power signal to drive a load to operate, comprising:
a sinusoidal-wave signal generator, receiving said first power signal and outputting a sinusoidal-wave frequency signal;
a signal amplifier, receiving said sinusoidal-wave frequency signal and providing a gain for a driving signal output from the signal amplifier;
a transformer unit, receiving said driving signal to undertake a power transformation and outputting said second power signal to drive said load to operate.

2. The inverter driving circuitry according to claim 1, wherein said sinusoidal-wave signal generator outputs a standard sinusoidal-wave frequency.

3. The inverter driving circuitry according to claim 1, wherein said first power signal input from said power unit is a direct current power signal.

4. The inverter driving circuitry according to claim 1, wherein said first power signal input from said power unit is a pulse direct current power signal.

5. The inverter driving circuitry according to claim 1, wherein said inverter driving circuitry utilizes a single set of said sinusoidal-wave signal generator and said signal amplifier to drive more than two said transformer unit.
